(19) United States
(12) Patent Application Publication
(10) Pub. No.: US 2012/0325829 A1
(43) Pub. Date: Dec. 27, 2012

(54) METHOD FOR PRODUCING BLOW-MOLDED CONTAINERS AND BLOW-MOLDED CONTAINER

(75) Inventors: Jens-Uwe Haubenschild, Hamburg (DE); Pisarn Pasutanon, Hamburg (DE)

(73) Assignee: KHS CORPOPLAST GMBH, HAMBURG (DE)

(21) Appl. No.: 13/581,440

(22) PCT Filed: Jan. 13, 2011
(86) PCT No.: PCT/DE2011/000044

§ 371 Date: Aug. 27, 2012

(30) Foreign Application Priority Data
Feb. 25, 2010 (DE) 10 2010 009 926.0

(51) Int. Cl. B65D 25/00; B29C 49/06

(52) U.S. Cl. 220/628; 264/537

(57) ABSTRACT

The blow-moulded container (1) has a closable mouth portion (2), a side wall (3) and a closed base (4) with standing feed (7). The material in the region of the base is shaped by blow moulding an injection-moulded preform in such a way that, in at least one vertical sectional plane, a distance (8) between two standing feet becomes less, at least in certain portions, in a vertical direction of the container from the top downwards.

The invention relates to a method for producing a blow molded container which includes a closable mouth portion, a side wall, as well as a closed bottom with feet.

Moreover, the invention relates to a blow molded container which includes a closable mouth portion, a side wall, as well as a closed bottom with feet.

When shaping containers by the influence of blowing air, preforms of a thermoplastic material, for example, preforms of PET (polyethylene terephthalate), are conveyed within a blow molding machine to different processing stations. Typically, such a blow molding machine includes a heating unit, as well as a blow molding unit in whose areas the previously thermally adjusted preform is expanded into a container by biaxial orientation. The expansion takes place by means of compressed air which is conducted into the preform to be expanded. The process-technological sequence of such an expansion of the preform is explained in DE-OS 43 40 291. The introduction of the pressurized gas mentioned above also includes the introduction of pressurized gas into the developing container bubble, as well as the introduction of pressurized gas into the preform at the beginning of the blow molding process.

The basic construction of a blow molding station for shaping containers is described in DE-OS 42 12 583. Possibilities for thermally adjusting the preforms are explained in DE-OS 23 52 926.

The preforms, as well as the blow molded containers, can be transported within the blow molding device by means of various manipulating devices. In particular, the use of transport mandrels, onto which the preforms can be placed, has been found useful. However, the preforms can also be manipulated by means of other support devices. The use of gripping tongs for manipulating preforms and the use of spreading mandrels, which can be inserted into a mouth portion of the preform for support, are also among the available constructions.

A manipulation of containers with the use of transfer wheels is described, for example, in DE-OS 199 06 438, in an arrangement of the transfer wheel between a blow molding wheel and a discharge section.

The manipulation of the preforms already explained above takes place, on the one hand, in the so-called two-stage method, in which the preforms are initially produced in an injection molding process, are subsequently subjected to storage, and are only later conditioned with respect to their temperature and blown up into a container. On the other hand, the so-called single-stage methods can be used in which the preforms are suitably thermally adjusted and subsequently blown up immediately following their manufacture by injection molding technology and a sufficient solidification.

With respect to the blow molding stations used, various embodiments are known. In blow molding stations which are arranged on rotating transport wheels, a book-like opening of the mold carriers can be frequently found. However, it is also possible to use mold carriers which are slidable relative to each other or guided in a different manner. In stationary blow molding stations, which are particularly suitable for receiving several cavities for the formation of containers, typically plates arranged parallel to each other are used as mold carriers.

Prior to heating, the preforms are typically placed on transport mandrels which transport the preforms either through the entire blow molding machine, or which revolve only in the area of the heating unit. In a stationary heating of the preforms, such that the openings of the preforms are oriented downwardly in the vertical direction, the preforms are usually placed on a sleeve-like holding element of the transport mandrel. When the preforms are heated in a suspended state, in which the preforms are oriented upwardly with their openings in the vertical direction, usually spreading mandrels are inserted into the openings of the preforms for clamping the preforms.

Such blow molded containers are used in a multitude of configurations for packaging products. In particular, non-carbonated or carbonated beverages are filled into such containers.

When manufacturing the respective containers, a significant cost factor is the weight of the material used. On the one hand, the material is relatively expensive; in addition to that, heating of the material prior to blow molding is required which results in significant use of energy. Therefore, it is being continuously attempted to reduce the use of material and to construct the blow molded containers with walls that are as thin as possible.

However, the reduction of the wall thickness leads to a reduced stability of the containers. Therefore, in the area of the side walls of the containers, special ribs are provided. Also, in the area of the bottom of the container, attempts are made to reduce the wall thickness. In containers, which are provided with feet in the bottom area, the efforts for continuously reducing the material use were met with limitations because in the area of the feet, notch-like collapsing points were formed when the wall thickness in the area of the legs was below a minimum wall thickness. These collapsing points negatively affect the appearance of the bottles; moreover, the stability however is also negatively affected and, if the collapsing points are formed prior to filling of the containers, inaccuracies of the dispensed quantities cannot always be avoided.

Therefore, it is the object of the present invention to improve a method of the above-mentioned type in such a way that the stability of the bottom area of the container is improved.

In accordance with the invention, this object is met by thermally adjusting an injection molded preform and by deforming the preform by a blow molding process into a container in such a way that the material in the area of the bottom is shaped by the blow molding process in such a way that, in at least one vertical sectional plane, a distance between two feet decreases in a vertical direction of the container, at least in sections from the top toward the bottom.

Another object of the present invention is to construct a container of the above-mentioned type in such a way that improved stability properties are made available.

In accordance with the invention, this object is met by shaping the material of the bottom by blowing deformation of an injection molded preform in such a way that at least in one vertical sectional plane, a distance between two feet in a vertical direction of the container decreases at least over sections from the top toward the bottom.

In accordance with the prior art, the outer surfaces of the feet narrow in the manner of a triangle in a vertical direction from the top toward the bottom. This also results in a triangle-like expansion of the spacing between the feet in a vertical direction from the top to the bottom.

This triangle-like narrowing of the feet and the corresponding triangle-like expansion of the distance results in side surfaces of the feet, which are arranged in almost the entire area of its extension completely relative to a vertical direction. However, weight forces introduced from the filled containers into the feet and pressure forces produced by the filling material have essentially a vertical direction, so that the respective force introductions lead to deformations of the feet.

The configuration of the feet according to the invention results in a significantly better force transmission by the feet, and deformations can be substantially reduced. In particular, the notch-like collapsing points in the area of the bottom side of the feet mentioned above, no longer occur.

A particularly high stability with respect to shape can be achieved if the distance in the vertical direction from the top toward the bottom initially decreases, then increases.

A good compromise between a high stability and a good deformability is achieved by providing the bottom with five feet.

Another increase of the mechanical stability in the bottom area can be achieved by providing an outer contour of the feet in a vertical direction with a waist-like narrow middle.

A favorable transmission of weight forces is supported by providing the feet, at least over sections thereof, with an essentially vertically extending side wall.

Embodiments of the invention are schematically illustrated in the drawing. In the drawing:

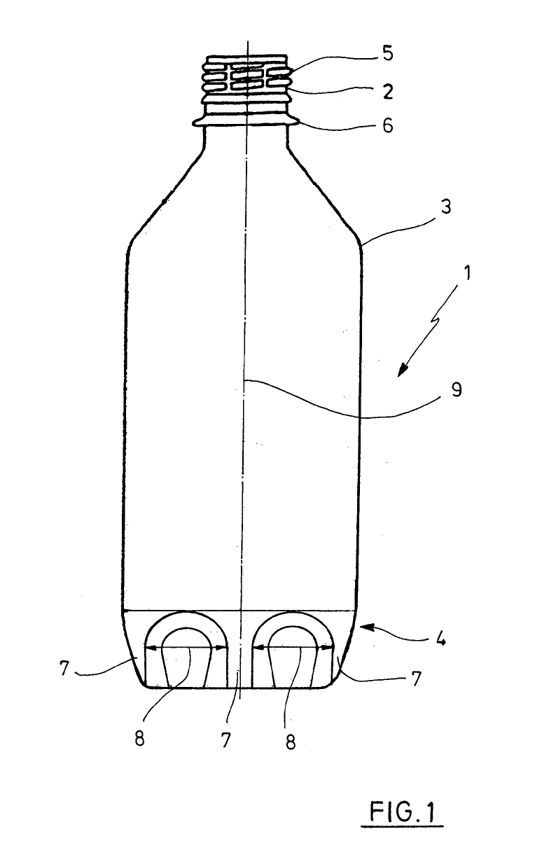

FIG. 1 is a schematic illustration of a blow molded container with feet,

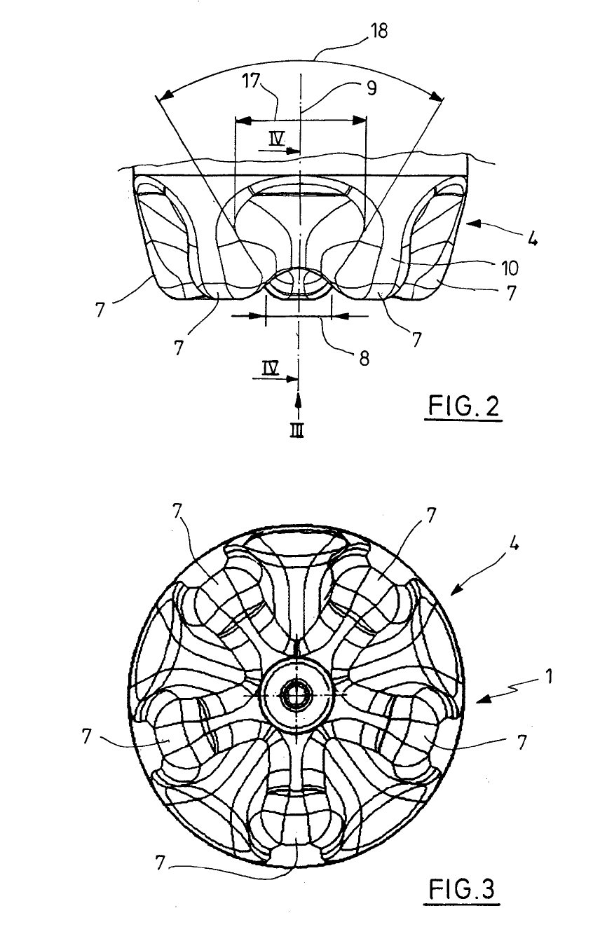

FIG. 2 is a side view, on a larger scale, of the bottom area of the container,

FIG. 3 is a top view in the viewing direction III in FIG. 2,

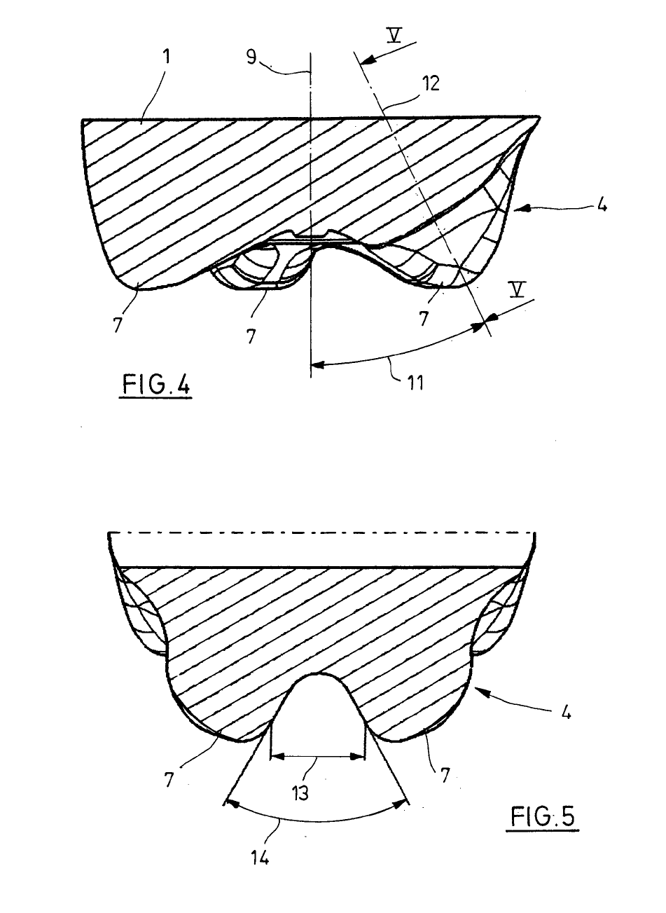

FIG. 4 is a vertical sectional view along sectional line IV-IV in FIG. 2,

FIG. 5 is a cross-sectional view along sectional line V-V, in FIG. 4,

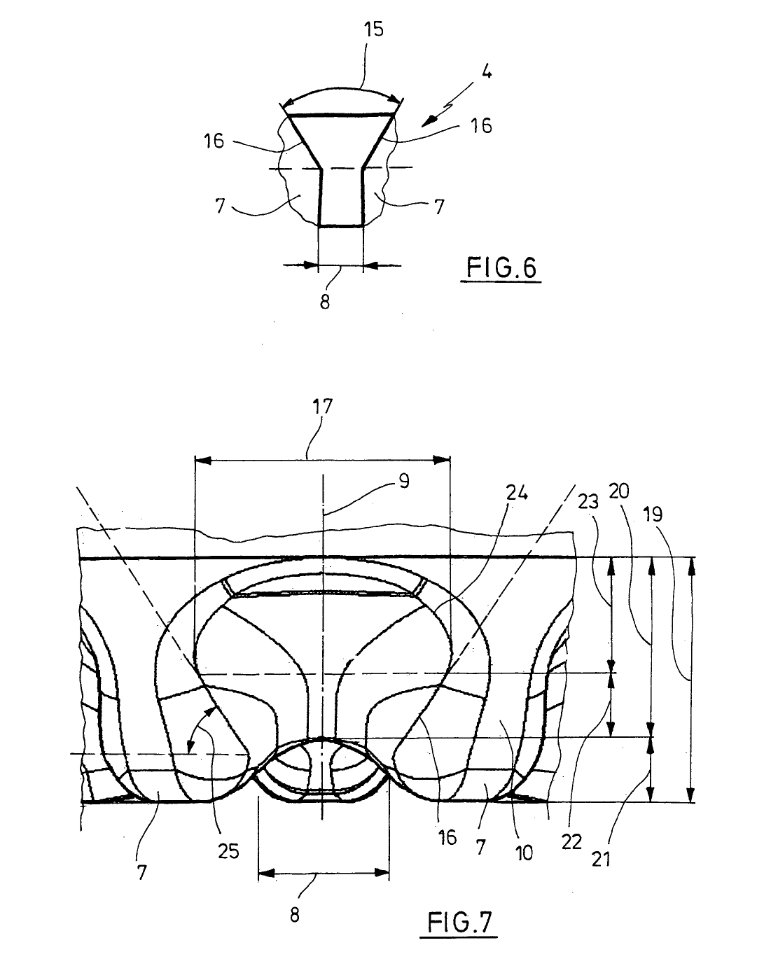

FIG. 6 is a schematic illustration for showing a pattern of spacing between two adjacent feet, and

FIG. 7 is a side view, on a larger scale, of the bottom according to FIG. 2 with additional auxiliary lines.

FIG. 1 shows a blow molded container 1 which has a mouth portion 2, side walls 3 and a bottom 4. The mouth portion 2 is provided with an external thread 5 and is separated from the side walls 3 by a support ring 6.

A plurality of feet 7 are arranged in the area of bottom 4, wherein respective spacings 8 extend between the feet. The container 1 extends along a longitudinal axis 9.

From FIG. 2 it can be seen that the outer surfaces 10 of the feet 7 do not narrow more or less steadily in the direction of the longitudinal axis 9 from the top toward the bottom, as is the case in the prior art, but extend in a lower portion at least approximately with a constant width. This is achieved by having the spacing 8 also not steadily expand in the direction of the longitudinal axis 9 from top to bottom, but by providing a reduction of the spacing 8 at least over portions in this direction.

FIG. 3 shows a top view of the bottom 4 in accordance with viewing direction III in FIG. 2. It can be seen that five feet 7 are provided in the illustrated embodiment. The feet 7 are arranged in a circumferential direction of the container 1 so as to be essentially equidistant relative to each other.

The arrangement of the feet 7 can once again be seen in the longitudinal sectional view of FIG. 4. Additionally illustrated is an angle 11 which extends between the longitudinal axis 9 of the container 1 and a sectional line 12 of the feet 7.

FIG. 5 shows a sectional plane V-V within which also the sectional line 12 extends, a width 13 between two adjacent feet 7, and an angle 14 between adjacent side surfaces of the feet 7. For a container 1 with an internal volume of about 0.51, a typical width 13 is 14 mm, and the angle 14 has a value of about 60°.

FIG. 6 shows the pattern of spacing between two adjacent feet 7 in a vertical direction. It can be seen that the distance between the feet 7 initially decreases and then essentially remains the same or increases again. In the illustrated embodiment, the decrease of the spacing takes place in accordance with an angle 15 between adjacent side surfaces 16 of the feet 7. The decrease of the spacing extends, in this case, from the top toward the bottom approximately over half the height of the feet 7 and in the upper half of the feet 7.

Going back to FIG. 2, for the already explained filling volume of about 0.51, this means that the width 17 is about 20 mm to 25 mm and an angle 18 is about 50° to 65° . In the case of a combination of the illustrations of FIG. 2 and FIG. 5, a typical quotient of the width 17 and the width 13 is above 1.0. A typical interval is defined by a range of values of 1.4 to 1.9. A value of about 1.8 is considered optimal.

A quotient of the angle 18 and the angle 14 typically has a value in the interval of 0.8 to 1.1. A value of about 0.95 is considered optimal. A typical height of the feet 7 in the direction of the longitudinal axis 9 is about 2.5 to 3 cm. A value of about 2.8 cm is typical.

The angle 18 in FIG. 2 corresponds essentially to the angle 15 in the schematic illustration according to FIG. 6.

The typical values for the dimensions indicated above change with different volumes of the containers 1. Typically, a scale is used which is essentially proportional to the change of the diameter of the containers 1.

For the already mentioned container 1 having a filling volume of 0.51, a typical weight for the container 1 is about 13.3 g, of which about 2.9 g is the weight of the bottom 4.

FIG. 7 shows in a substantially enlarged illustration the bottom 4, according to FIG. 2, with additional auxiliary lines for further explaining the geometric relationships. The feet 7 have, in the direction of the longitudinal axis 9, a height 19. Consequently, this height 19 also corresponds to the height of the distance 8 in the direction of the longitudinal axis 9. When taking into consideration the sectional views, especially in FIG. 4, it can be seen that the spacing range 8 is delimited by a three dimensionally curved contour. The schematic illustration in FIG. 6 describes a projection of this spacing range in a horizontal plane transversely of the longitudinal axis 9 in accordance with FIG. 3, on the one hand, and the projection of this spacing range in the enveloping surface of the container 1 on the other hand in accordance with FIG. 7. In the following, with reference to FIG. 7, this projection onto the enveloping surface of the container 1 is described in a simplified manner, wherein, in accordance with an exact observation, this enveloping surface has been developed in a plane.

In a joint observation of FIG. 6 and FIG. 7, it can be seen that the height 19 is divided into an upper portion 20 in which the spacing 8 between the feet 7 decreases and, a lower portion 21 in which the spacing 8 remains essentially equal or increases again. Typically, the upper portion 20 is about twice as long as the lower portion 21. A quotient of the upper portion 20 and the lower portion 21 typically has a value in the range of 2.0 to 2.5.

The upper portion 20, in turn, is divided into base portion 22 and a cupola portion 23. The projections of the side surfaces 16 into the enveloping surface of the container 1, visible in FIG. 7, extend approximately in straight lines within the base portion 22. A connection of these side surfaces 16 is then carried out in the cupola portion 23 with a contour whose projection corresponds approximately to half an ellipse. Accordingly, there is a pattern of the projection line similar to half an ellipsoid contour.

The angle 25 shown in FIG. 7, between the side surfaces 16 and a horizontal plane, corresponds to half the angle 18 which is shown in FIG. 2. Consequently, the angle 25 has a value of about 60 to 75°.

1-10. (canceled)

11. A method for manufacturing a blow molded container which includes a closable mouth portion, a side wall, and a closed bottom with feet, the method comprising thermally adjusting a deforming an injection molded preform by a blow molding process to form a container, whereby material in an area of the bottom is shaped by the blow molding process so that in at least one vertical sectional plane, a spacing between two feet in a vertical direction of the container decreases at least over sections from a top toward the bottom.

12. The method according to claim 11, wherein the spacing initially decreases in the vertical direction from the top toward the bottom and then increases.

13. The method according to claim 11, including providing the bottom with five feet.

14. The method according to claim 11, including providing an outer contour of each of the feet in a vertical direction with a waist-like narrow middle.

15. The method according to claim 11, including providing at least over sections, with an essentially vertically extending side wall.

16. A blow molded container, comprising: a closable mouth portion; a side wall; and a closed bottom with feet, wherein the material in the area of the bottom is shaped by blowing deformation of an injection molded preform in such a way that, in at least a vertical sectional plane, a distance between two of the feet decreases in the vertical direction of the container at least over sections from a top toward the bottom.

17. The blow molded container according to claim 16, wherein the distance in the vertical direction initially decreases and then increases.

18. The blow molded container according to claim 16, wherein the bottom has five feet.

19. The blow molded container according to claim 16, wherein each of the feet has, in a vertical direction, a waist-like narrow middle.

20. The blow molded container according to claim 16, wherein a side wall of the feet extends at least over sections essentially in a vertical direction.
